(19) United States
(12) Patent Application Publication
(10) Pub. No.: US 2013/0103411 A1
(43) Pub. Date: Apr. 25, 2013

(54) Systems and methods for reducing healthcare transaction costs

(71) Applicants: George E. Bogle, Lakeway, TX (US); George M. Bogle, Phoenix, AZ (US)

(72) Inventors: George E. Bogle, Lakeway, TX (US); George M. Bogle, Phoenix, AZ (US)

(73) Assignee: USA Senior Care Network, Inc., Phoenix, AZ (US)

(21) Appl. No.: 13/317,515

(22) Filed: Oct. 20, 2011

(51) Int. Cl. G06Q 50/22; G06Q 40/08

(52) U.S. Cl. 705/2

(57) ABSTRACT

A centralized network can be established by contracting medical facilities and insurance providers, in which the medical facilities agree to waive all or a portion of a deductible amount owed as part of their contractual obligation with the network. The insurance providers agree to provide a credit of the premium to be paid by beneficiaries that use a contracted medical facility to receive a service for which the deductible amount is waived. Specific uses of the systems and methods disclosed can include management of a Medicare supplemental insurance network in which Part A deductibles are waived by hospitals or similar medical facilities, and premium credits are provided to beneficiaries of Medicare supplemental insurance policies who use contracted medical facilities. The cost savings and increased revenue recognized by both medical facilities and insurance providers can enable claims to be repriced while reducing transactional costs for all parties.

### FIELD

The present invention relates, generally, to methods and systems usable to reduce costs of healthcare transactions and increase revenues. More specifically, embodiments described herein include methods and systems for reducing costs associated with insured patients, such as insurance premiums, and costs associated with insurance providers, such as deductible amounts, while increasing revenues to both medical facilities and insurance providers by providing an incentive for patients to use contracted medical facilities and contracted insurance providers that have agreed to a system of practices and incentives.

### BACKGROUND

In the United States, Medicare is administered by the government as a social insurance program, used to provide health insurance to citizens age sixty-five and older, as well as disabled individuals and those who meet other criteria. Medicare includes hospital insurance (“Part A”), which covers costs associated with hospital stays, use of skilled nursing facilities, hospice or home healthcare, and other similar expenses. Medicare also includes medical insurance (“Part B”), which covers most doctors' services, clinical and laboratory costs, home healthcare, outpatient services, and similar costs.

While Medicare can help covered individuals avoid catastrophic expenses, some Medicare plans only cover a portion (typically 80%) of expenses related to certain procedures, while the beneficiary is responsible for the remainder of the associated costs. Additionally, Medicare Part A includes a deductible amount (for example, $1,132 in 2011), which must be paid by the beneficiary. Further, any hospital stays that exceed sixty days in length incur a daily cost that must be paid by the beneficiary, and any hospital stays that exceed ninety days require a greater daily cost to be paid and consume a limited number of “lifetime reserve days” allotted to each beneficiary. Once these lifetime reserve days are used, the full cost of each successive day of a hospital stay must be paid by the beneficiary. Similar policies, such as coinsurance for use of skilled nursing facilities, apply to other types of medical facilities.

Thus, even though Medicare covers the costs associated with a large portion of a beneficiary's healthcare transactions, beneficiaries remain burdened with considerable expenses not covered by Medicare, which can constitute a significant hardship for senior citizens and disabled individuals. As such, many private insurance companies offer supplemental insurance policies for Medicare beneficiaries, colloquially termed “Medigap” policies. While the premiums assessed by insurance providers for such policies are normally very costly, most Medicare supplemental insurance policies cover a patient's Medicare Part A deductible, as well as any portion of a healthcare expense not covered by Medicare. Many supplemental insurance policies also cover expenses associated with hospital stays that exceed the length covered by Medicare.

Many beneficiaries are unable to pay the costs associated with medical expenses not covered by Medicare, and hospitals are forced to write off these costs as uncollectable bad debts. As such, hospitals and other medical facilities strongly prefer treating patients covered by Medicare supplemental insurance policies due to the fact that revenue supplied by an insurance provider is not subject to the risk of becoming uncollectable in the same manner as an amount owed directly by a patient.

A need therefore exists for systems and methods that can facilitate reduced premium expenses for beneficiaries of Medicare supplemental insurance policies, enabling a larger number of patients to obtain coverage by such policies.

A need also exists for systems and methods that increase hospital revenues, decrease transactional costs for hospitals and insurance providers, and reduce the number of patients not covered by a Medicare supplemental insurance policy.

Embodiments usable within the scope of the present disclosure meet these needs.

### SUMMARY

Embodiments described herein relate, generally, to systems and methods for reducing costs of healthcare transactions, including transactions between healthcare facilities and insurance providers that relate to Medicare claims, while the systems and method themselves are not part of Medicare or the Medicare payment process. A plurality of medical facilities (e.g., hospitals, skilled nursing facilities, home healthcare providers, hospices, and similar facilities) can be contracted to waive at least a portion of an inpatient deductible for a group of insured patients. Concurrently, a plurality of insurance providers can be contracted to provide a premium credit to each insured patient that conducts an inpatient healthcare transaction with a contracted medical facility.

For example, contracted hospitals can agree to waive all or a portion of the Medicare Part A deductible for all Medicare patients who have Medicare supplemental insurance coverage that elect to use their facility. Concurrently, a provider of a Medicare supplemental insurance policy can agree to provide a patient with a $100 premium credit when the patient chooses to use a hospital that has agreed to waive all or a portion of the Medicare Part A deductible.

Medicare beneficiaries who have Medicare supplemental insurance coverage are thereby provided with an incentive to use contracted hospitals to receive the premium credit while remaining free to use other Medicare-participating facilities as well. Thus, Medicare beneficiaries who have Medicare supplemental insurance coverage avoid payment of the Medicare Part A deductible, which is a covered benefit through their contracted insurance provider, and can also receive reduced premium expenses through the premium credit. Additionally, Medicare beneficiaries who have Medicare supplemental insurance coverage, whether they use a contracted hospital or not, benefit from the savings resulting from the Part A deductible waivers because the contracted insurance providers use these savings to reduce the severity of premium rate increases for all policyholders.

While hospitals and other medical facilities would incur costs associated with waiving all or a portion of a deductible, medical facilities would see increased revenue through additional patients that would be incentivized to select a contracted medical facility. Additionally, incentivized patients that are covered by contracted insurance policies would provide a reliable source of revenue for medical facilities, reducing the number and the impact of bad debts and uncollectable patient balances. Demographic and/or financial data can be analyzed (e.g., via a computer-based analysis) to identify medical facilities suitable for contracting, and/or to determine whether contracting to waive a deductible amount would be profitable for a medical facility.

While contracted insurance providers would incur the cost associated with providing a premium credit to beneficiaries, insurance providers would also see increased revenue through additional enrolled beneficiaries incentivized by such premium credits, and cost savings associated with the waiver of all or a portion of the deductible amount by contracted medical facilities. Additionally, the increased revenue and reduced risk experienced by medical facilities can enable claims submitted to insurers to be repriced, further reducing the costs borne by insurance providers. Similarly, the waiver of a deductible amount by contracted medical facilities can enable claims to be repriced by insurers in a manner more profitable to medical facilities.

Thus, embodiments of the present invention provide for the management of a Medicare supplemental insurance network in which a healthcare provider waives all or a portion of the Part A deductible owed for services rendered, as part of its contractual obligation with the Medicare supplemental insurance network. In turn, a Medicare supplemental insurance provider receives a claim from the healthcare provider, reprices the claim based on the Part A deductible waiver, and then issues payment to the healthcare provider based on the repriced claim. The Medicare supplemental insurance provider can then issue a report to the Medicare supplemental insurance network for claims incurred, and may also issue a fee payment to the Medicare supplemental insurance network, which can be based on the amount saved and/or an amount of increased revenue experienced.

### BRIEF DESCRIPTION OF THE DRAWINGS

In the detailed description of various embodiments of the present invention presented below, reference is made to the accompanying drawings, in which:

FIG. 1 depicts a prior art diagram showing the interactions between a hospital, Medicare, a supplemental insurance provider, and a beneficiary.

FIG. 2 depicts a diagram showing interactions between a contracted hospital, Medicare, a contracted supplemental insurance provider, and a beneficiary using embodiments of the present systems and methods.

Embodiments of the present invention are described below with reference to the listed Figures.

### DETAILED DESCRIPTION OF THE EMBODIMENTS

Before explaining selected embodiments of the present invention in detail, it is to be understood that the present invention is not limited to the particular embodiments described herein and that the present invention can be practiced or carried out in various ways.

Embodiments usable within the scope of the present disclosure relate to systems and methods that utilize a network of contracted medical facilities and insurance providers, each of which have agreed to provide certain incentives that may cause patients to preferentially conduct healthcare transactions with contracted medical facilities, while permitting the patients to elect to use non-contracted medical facilities if desired. In a specific embodiment, a plurality of contracted medical facilities can agree to waive all or a portion of an inpatient deductible amount normally paid by a patient and/or by the patient's insurance provider. Concurrently, a plurality of contracted insurance providers can agree to provide a beneficiary with a premium credit (e.g., $100, issued as a payment certificate or notice of automatic credit toward payment of the next premium), on each occasion that the beneficiary completes an inpatient healthcare transaction at a contracted medical facility for which the deductible amount is waived. As a result, patients may preferentially choose to use contracted medical facilities and contracted insurance providers, resulting in larger and more reliable revenue streams, and decreased costs for all parties involved. Optionally, the amount of premium credits received by a beneficiary within a selected time period can be limited, (e.g., a maximum of $600 in premium credits annually). Throughout this process, the network itself (e.g., any contracts between medical facilities, insurance providers, and/or a third party network) can remain invisible to patients, who simply conduct healthcare transactions with medical facilities and insurance providers in the manner in which such transactions would normally occur.

Medical facilities suitable for contracting can be identified in various manners. In an embodiment, admissions data can be received from a hospital or other type of medical facility. Specifically, the number of reported admissions for a geographic area (e.g., a state) can be identified, and this number can be used to extrapolate the number of insured patients within the geographic area. For example, based on historically reported data, a policyholder for a Medicare supplemental insurance policy experiences approximately 0.26 admissions per year. Using the inverse of this number (1/0.26=3.846), it can be estimated that each admission is representative of approximately 3.85 policyholders. Thus, for 100 admissions, the following equation could be applied:

100*(1/0.26)=100*3.846=384.6 policyholders per 100 admissions

It should be understood, however, that the specific value used to extrapolate an estimated number of policyholders can vary based on geographic region, the type of insurance policy, patients, and/or medical facility being considered, changes or trends over time in historical data, and/or other similar factors. As such, use of the inverse of 0.26 is an exemplary embodiment based on current historical data relating to Medicare supplemental insurance policies; however, this value may change over time as medical, patient, and/or governmental practices change, or other values may be used with regard to different patient populations and/or insurance policies.

Demographic data can be analyzed to determine a specific area (e.g., a 3-digit zip code area within a state) within which admissions occurred. This data can be used to project the number of medical facilities needed to treat existing insured beneficiaries, and to account for future growth. A market analysis can then be conducted, e.g., using financial statements from one or more medical facilities in the specific area, to determine the percentage of revenue associated with a group of insured patients (e.g., Medicare beneficiaries).

In an embodiment, a computer-based analysis (e.g., using a processor in communication with computer instructions) can be performed to analyze the percentage of revenue associated with a selected group of insured patients, the extrapolated number of insured patients, other demographic and/or financial data, the number of reported admissions, and/or other data specific to a location, insurance policy, or group of patients. The results of such an analysis can determine whether the expected increased revenue of a medical facility resulting from additional patient traffic resulting from the present methods and systems will exceed the cost associated with waiving all or a portion of the deductible amount. For example, if only a small percentage of a hospital's revenue is obtained through services provided to Medicare beneficiaries, but demographic data indicates a large number of individuals covered by Medicare supplemental policies are located in areas served by the hospital, the analysis may determine that the increased revenue generated by offering a premium credit and/or other incentives to patients covered by Medicare supplemental policies to utilize a specific medical facility will exceed the cost of waiving all or a portion of the Part A deductible amount for such patients.

In a further embodiment, medical facilities suitable for contracting can be identified by first identifying a market area using census data, and determining one or more medical facilities within that area. Market areas can be determined by identifying areas with a high population density and/or a large number of hospital admissions. In an embodiment, such an analysis can be performed using computer instructions adapted for such a purpose.

The payer mix of each medical facility can be analyzed to determine a percentage of revenue associated with a group of insured patients. For example, the financial data of a hospital or other medical facility can be analyzed to determine revenue streams from Medicare, Medicaid, and/or Commercial or Self-Pay. Following this financial analysis, the admission count and/or the average length of stay for one or more groups of insured patients can be determined.

A computer-based analysis (e.g., using a processor in communication with computer instructions) can be performed, thereby analyzing the one or more percentages of revenue determined, the admission count, the average length of stay, and/or other relevant factors, to determine whether a group of insured patients constitutes a loss leader. For medical facilities in which a group of insured patients constitutes a loss leader, the increased revenue generated by incentivizing patients from this group to utilize a specific medical facility will typically exceed the cost of waiving all or a portion of the deductible amount for such patients.

Medical facilities can further be graded based on various standards, such as services offered, outcomes reporting, re-admission rates, admitting privileges from physicians (e.g., specialists) in the area, and/or other similar factors, thus enabling hospitals and/or other facilities to be ranked in order of desirability and/or the potential benefits of contracting through the present systems and methods.

For example, the benefits to a medical facility obtained through contracting and utilizing the present systems and methods can be summarized through the following equation:

X=[(R+S)−(D*A)]/N

In the above equation, X represents the benefit to a hospital or other medical facility (measured in terms of new patient revenue), R represents revenue due to increased admissions (e.g., from additional patients incentivized by the waiver of a deductible amount and/or premium credits from an insurance provider), and S represents the value of a payment from an insurance carrier (e.g., payment of a claim by a Medicare supplemental insurance policy). D represents the amount of a deductible payment that is waived, A represents an adjusted revenue amount (based on retrospective payments through CMS), and N represents the number of new patient admissions.

Thus, when the sum of revenue received for increased admissions and the value of insurance payments exceeds the product of the amount of deductible waived times the adjusted revenue, a medical facility will experience a financial benefit through the present systems and methods.

It should be understood that while various methods for determining whether contracting a medical facility will be suitable and/or profitable, any hospital or similar medical facility that accepts covered beneficiaries (e.g., Medicare patients) can be contracted and utilized in embodiments of the present systems and methods, independent of determinations made through demographic and/or financial data, without departing from the scope of the present disclosure.

Insurance providers can be contracted following a review of historical data. For example, a provider of a Medicare supplemental insurance policy can provide a 12-month Part A claims history, thus enabling projected access needs and historical access patterns to be analyzed. A disruption study can also be performed, in which any hospitals or other facilities listed in the 12-month Part A claims history are compared to existing contracted medical facilities. Following this analysis, a determination can be made regarding whether contracting the insurance provider in question will necessitate contracting additional medical facilities to ensure adequate patient access.

As medical facilities and/or insurance providers are contracted, a list of all contracted facilities and/or providers can be maintained, and distributed to all contracted facilities and/or providers periodically (e.g., monthly) to assist beneficiaries in locating the nearest contracted medical facility. A readily available, network-accessible list can also be maintained, such as by providing a link to the list on the website of one or more insurance providers.

To facilitate transactions between contracted medical facilities and insurance providers, beneficiaries can be provided with identification cards that can be presented at a contracted medical facility at the time care is received, such that the healthcare transaction can be properly processed. For example, upon receipt of an identification card, a medical facility can waive all or a portion of a patient's Medicare Part A deductible and transmit this information to the beneficiary's insurance provider, so that a premium credit can be provided to the beneficiary.

Thus, in an exemplary embodiment, a beneficiary can receive medical care at a medical facility, and can experience cost savings while doing so, in the form of a premium credit provided by the patient's insurance provider. Additionally, it is contemplated that due to cost savings to insurance providers in the form of waived deductible payments and lower transactional costs, contracted insurance providers may be able to assess lower premiums to beneficiaries. The medical facility recognizes increased revenue through steerage of patients, who preferentially use contracted medical facilities due to the incentives offered, and through the guaranteed revenue stream provided by an insurance provider, minimizing the risk of uncollectable balances. Insurance providers recognize increased revenue through patients who perferentally use contracted insurance providers due to the incentives offered, through the waiver of deductible amounts, and through the ability to reprice claims due to the cost savings experienced by both medical facilities and insurance providers.

For example, upon discharge of a patient and completion of a hospital's billing process, a contracting hospital can send a bill to Medicare for processing. After receiving remittance and an explanation of benefits from Medicare, the remittance can be provided to a contracted provider of the patient's Medicare supplemental insurance policy for processing. At this time, the claim can be repriced by the insurance provider, or alternatively, a third party (e.g., a representative of the network of contracted medical facilities and insurers) can reprice the claim, such as through use of a computer-based analysis or similar algorithm.

As part of a centralized network, contracted medical facilities and insurance providers can agree to various terms of operation. For example, in an embodiment, insurance providers can be obligated to complete medical bill processing and payment within thirty days of receiving a remittance. Similarly, medical facilities and/or insurance providers can be obligated to use certain repricing standards, use certain contractual language indicating waiver of a deductible amount when providing an explanation of benefits, or other similar terms of operation.

In an embodiment, insurance providers can send a monthly report (e.g., to a centralized network) detailing all deductibles incurred by their policyholders in the preceding months. A second report can be provided that is specific to all deductibles waived and payments made to contracted medical facilities. These reports can then be compared to one another, e.g., by a third party network representative, to avoid errors, omissions, and/or duplications, and to retain information for trending and analysis purposes. Retained information can include number of admissions by company, by state or other geographic region, and/or by month or other time period. Such information can also include the number of admissions to a contracted medical facility that were omitted from reports submitted by contracted insurance providers, the value of any non-utilized Part A waivers for the previous month and the identification of relevant medical facilities for refund requesting purposes, and/or the total number and location of all admissions to non-contracted medical facilities.

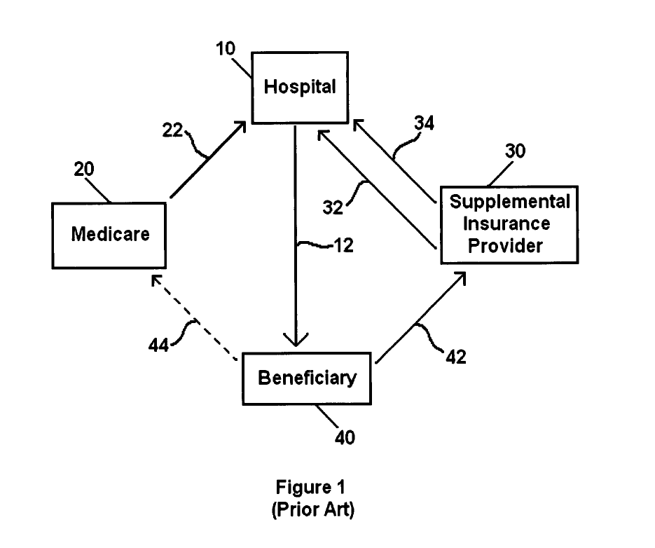

Referring now to FIG. 1, a diagram depicting conventional interactions that occur between a hospital (10), Medicare (20), a supplemental insurance provider (30), and a beneficiary (40) is shown.

Typically, a hospital (10) provides a medical service (12) to a beneficiary (40). The beneficiary (40) obtains coverage from Medicare (20), provided that the beneficiary (40) is qualified to receive such coverage (e.g., due to age, disability, etc.). Under some circumstances, a beneficiary (40) must pay Part A premiums (44) to receive such coverage. For example, if the beneficiary (40) or a spouse has not undertaken forty quarters of Medicare-covered employment, Part A premiums (44) would be owed.

The beneficiary (40) can also receive coverage from the supplemental insurance provider (30) through payment of insurance premiums (42) thereto. Typically, the insurance premiums (42) assessed by a supplemental insurance provider (30) are costly; however, most Medicare supplemental insurance policies advantageously cover all or a portion of any medical cost not covered by Medicare (20).

Following provision of the medical service (12) to the beneficiary (40), the hospital (10) submits a claim to Medicare (20), responsive to which Medicare (20) provides a remittance (22) covering all or a portion of the cost of the medical service (12). Typically, the beneficiary (40) will be responsible for payment of a Part A deductible amount prior to receiving coverage from Medicare (20). Additionally the remittance (22) provided by Medicare (20) may only cover a portion (typically 80%) of the costs associated with the medical service (12), while the beneficiary (40) is responsible for payment of the remainder. Further, there exist certain medical services for which Medicare (20) will not provide coverage, such as the terminal portion of a hospital stay that exceeds 150 days.

As such, the supplemental insurance provider (30) pays the deductible amount (32) owed by the beneficiary (40) to the hospital (10). The supplemental insurance provider (30) also pays a remittance (34) to the hospital (10) for any costs not covered by Medicare (20), or only partially covered by Medicare (20).

Thus, in the depicted diagram, the beneficiary (40) must pay costly premiums (42) to obtain supplemental insurance coverage. As a result, many beneficiaries cannot afford such coverage, or elect not to purchase such coverage. Beneficiaries not covered by a Medicare supplemental insurance policy can incur significant financial responsibility if medical care is needed, and many hospitals must write off uncollectable patient balances as a result. Costs associated with healthcare services are often increased to account for uncollected debts.

The supplemental insurance provider (30) must pay not only the remittance (34) for costs not covered by Medicare (20), but must also pay a costly deductible amount (32) ($1,132 in 2011). Thus, the premiums (42) assessed by the supplemental insurance provider (30) are often costly to cover these expenses.

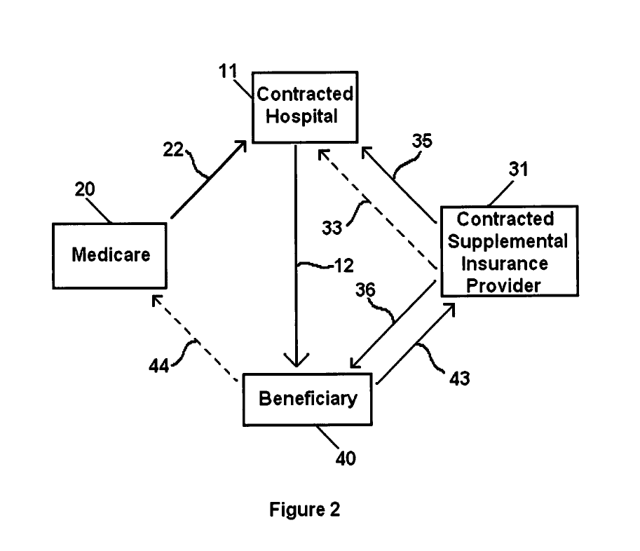

Referring now to FIG. 2, a diagram of an embodiment of a system usable within the scope of the present disclosure is shown, depicting the interactions between a contracted hospital (11), Medicare (20), a contracted supplemental insurance provider (31), and a beneficiary (40).

It should be noted that embodiments of the present systems and methods are not a part of Medicare and have no impact on the benefits due to a hospital or beneficiary under Medicare guidelines, nor on the obligations of a beneficiary to a hospital or to Medicare. As such, the interactions between the contracted hospital (11), Medicare (20), and the beneficiary (40) shown in FIG. 2 remain relatively unchanged from those shown in FIG. 1. FIG. 2 depicts the contracted hospital (11) providing a medical service (12) to the beneficiary (40). The beneficiary (40) may or may not be responsible for providing Part A premiums (44) to Medicare (20), as described previously. Responsive to receipt of a claim, Medicare (20) provides a remittance (22) to the contracted hospital (11), the remittance (22) covering all or a portion of the costs associated with the medical service (12).

Once contracted, the contracted hospital (11) agrees to waive all or a portion of the deductible amount owed by the beneficiary (40). As such, FIG. 2 depicts the contracted supplemental insurance provider (31) providing a partial or omitted deductible amount (33) to the hospital. FIG. 2 depicts the partial or omitted deductible amount (33) as a dashed line to illustrate that in various embodiments, no deductible amount may be owed (e.g., the contracted hospital may waive all of the Part A deductible amount), while in other embodiments, a partial deductible amount may be owed (e.g., the contracted hospital may waive a portion of the Part A deductible amount).

Due to the full or partial waiver of the deductible amount (33), the remittance provided by the contracted supplemental insurance provider (31) can be repriced. Thus, FIG. 2 depicts the contracted supplemental insurance provider (31) providing an adjusted remittance (35) to the contracted hospital (11).

Once contracted, the contracted supplemental insurance provider (31) agrees to provide a premium credit (36) to the beneficiary (40) for each transaction with a contracted hospital for which all or a portion of the Part A deductible amount is waived. Due to the provision of this premium credit (36), and additionally, due to the waiver of all or a portion of the deductible amount owed, the premiums assessed to the beneficiary (40) by the contracted supplemental insurance provider (31) can be modified. Thus, FIG. 2 depicts the beneficiary (40) providing a reduced premium (43) to the contracted supplemental insurance provider (31).

Therefore, while interactions between hospitals, beneficiaries, and Medicare remain unchanged, embodiments of the present systems and methods enable increased revenue and significant cost savings to contracted medical facilities and insurance providers, and to insured beneficiaries.

Contracted hospitals recognize increased revenue due to increased patient traffic, the patients being incentivized by the premium credits offered by insurance providers. Before contracting a hospital, an analysis can be performed to ensure that the revenue generated by increased patient traffic will exceed the cost incurred through waiving all or a portion of a deducible amount. Additionally, the increased revenue from patients covered by contracted insurance providers is not subject to becoming uncollectable in the same manner as a sum owed directly by a patient.

Contracted insurance providers recognize increased revenue due to an increased number of enrolled beneficiaries, the beneficiaries being incentivized by the offered premium credits. For example, waiver of the $1,123 Medicare Part A deductible amount by a contracted hospital will more than offset the cost incurred by a contracted supplemental insurance provider when providing a $100 premium credit to a beneficiary. As described above, the total amount of premium credit provided to a beneficiary within a given time period can be limited (e.g., $600 per year). Waiver of the deductible amount enables claims from a contracted hospital and remittance from a contracted insurance provider to be repriced, and can further enable the premiums assessed by the insurance provider to be favorably adjusted.

Beneficiaries recognize increased savings through the provision of a premium credit from a contracted insurance provider, and through potentially reduced premiums made possible by the waiver of the deductible amount. In light of the reduction in transactional costs, contracted insurance providers may further adjust the premiums assessed to beneficiaries, enabling a larger number of beneficiaries to more readily afford desired policies.

The present embodiments thereby facilitate reduced expenses and increased revenues for beneficiaries, medical facilities, and insurance providers, while reducing the number of patients not covered by a Medicare supplemental insurance policy.

While various embodiments of the present invention have been described with emphasis, it should be understood that within the scope of the appended claims, the present invention might be practiced other than as specifically described herein.

What is claimed is:

1. A method implemented by a network for reducing costs of a healthcare transaction, comprising:
forming a network of a plurality of medical facilities and a plurality of insurance providers;
forming an agreement between the plurality of medical facilities and the network, wherein the plurality of medical facilities agree to waive at least a portion of a deductible amount relating to inpatient healthcare transactions for a group of insured patients;
forming an agreement between the plurality of insurance providers and the network, wherein the plurality of insurance providers agree to provide a premium credit to each insured patient that conducts an inpatient healthcare transaction with at least one of the medical facilities;
enabling and causing, thereby, an insured patient to conduct an inpatient healthcare transaction with at least one of the medical facilities in the network, wherein said at least one of the medical facilities waives said at least a portion of the deductible for the insured patient pursuant to the agreement, and wherein at least one of the insurance providers associated with the insured patient provides the premium credit to the insured patient pursuant to the agreement; and
repricing a claim associated with the inpatient healthcare transaction based on increased revenue and reduced costs for the plurality of medical facilities and the plurality of insurance providers.

2. The method of claim 1, further comprising the step of identifying at least one medical facility for which contracting is predicted to increase revenue by:
identifying a number of reported admissions in an area;
extrapolating a number of insured patients using the number of reported admissions;
evaluating demographic data to determine at least one location associated with the number of reported admissions;
evaluating financial data of at least one medical facility within said at least one location to determine a percentage of revenue associated with the group of insured patients;
performing an analysis using a processor in communication with computer instructions for instructing the processor to analyze the percentage of revenue, the number of insured patients, the demographic data, the financial data, the number of reported admissions, or combinations thereof, to determine a prospective result; and
contracting said at least one medical facility if the prospective result indicates that increased revenue will exceed a cost associated with waiving said at least a portion of the deductible.

3. The method of claim 2, wherein the step of extrapolating the number of insured patients using the number of reported admissions comprises multiplying the number of admissions by the inverse of an expected number of admissions per year for an insured patient.

4. The method of claim 3, wherein the expected number of admissions per year is approximately 0.26.

5. The method of claim 1, further comprising the step of identifying at least one medical facility for which contracting is predicted to increase revenue by:
using census data to identify a market area;
identifying at least one medical facility within the market area;
determining a percentage of revenue of said at least one medical facility associated with the group of insured patients;
determining an admission count, an average length of stay, or combinations thereof, associated with the group of insured patients;
performing an analysis using a processor in communication with computer instructions for instructing the processor to analyze the percentage of revenue, the admission count, the average length of stay, or combinations thereof, to determine whether the group of insured patients constitutes a loss leader; and
contracting said at least one medical facility if the percentage of revenue, the admission count, the average length of stay, or combinations thereof, indicate that the group of insured patients constitutes a loss leader.

6. The method of claim 5, further comprising the step of making a determination whether contracting is expected to increase revenue of said at least one medical facility, wherein the determination comprises subtracting said at least a portion of the deductible times an adjusted revenue amount from the sum of an expected revenue from increased admissions and a quantity of insurance payments to obtain a value.

7. The method of claim 6, wherein the determination further comprises dividing the value by a number of expected new patient admissions.

8. The method of claim 1, further comprising the step of identifying at least one medical facility for which contracting is suitable by analyzing services offered, outcomes reporting, re-admission rates, admitting privileges from specialty physicians, or combinations thereof.

9. The method of claim 1, further comprising the step of periodically providing a list of the plurality of healthcare facilities to the plurality of insurance providers, periodically providing a list of the plurality of insurance providers to the plurality of healthcare facilities, or combinations thereof.

10. The method of claim 1, wherein said at least one of the insurance providers comprises a Medicare supplemental insurance provider, wherein said at least one of the medical facilities provides a bill to Medicare, wherein said at least one of the medical facilities receives a remittance from Medicare, wherein said at least one of the medical facilities submits a claim to the Medicare supplemental insurance provider, and wherein the Medicare supplemental insurance provider provides further funding to said at least one of the medial facilities.

11. The method of claim 10, further comprising the step of repricing the claim, repricing a cost of a policy associated with the Medicare supplemental insurance provider, or combinations thereof, based on increased revenue and reduced costs for the plurality of medical facilities and the plurality of insurance providers.

12. The method of claim 1, further comprising collecting a fee from said at least one of the medical facilities, said at least one of the insurance providers, or combinations thereof, wherein the fee is determined by an amount of increased revenue, an amount of decreased costs, or combinations thereof.

13. The method of claim 1, wherein the network is invisible to the insured patient.

14. A system for reducing costs of a healthcare transaction, the system comprising:
a plurality of contracted medical facilities, wherein the plurality of contracted medical facilities contract to waive at least a portion of a deductible for a group of insured patients; and
a plurality of contracted insurance providers, wherein the plurality of contracted insurance providers contract to provide a premium credit to each insured patient that conducts a healthcare transaction with at least one of the medical facilities,
wherein an insured patient conducts an inpatient healthcare transaction with at least one of the contracted medical facilities,
wherein said at least one of the contracted medical facilities waives said at least a portion of the deductible for the insured patient, and
wherein at least one of the contracted insurance providers associated with the insured patient provides the premium credit to the insured patient, thereby incentivizing insured patients to conduct healthcare transactions with the plurality of contracted medical facilities and increasing revenue of the plurality of contracted medical facilities, and thereby reducing costs of healthcare transactions for insured patients and the plurality of contracted insurance providers.

15. The system of claim 14, wherein the plurality of contracted medical facilities comprise hospitals, skilled nursing facilities, home healthcare providers, hospices, individual medical practitioners, a group of medical practitioners, or combinations thereof.

16. The system of claim 14, wherein the plurality of contracted insurance providers comprise Medicare supplemental insurance providers, and wherein the deductible comprises a Medicare Part A deductible.

17. The system of claim 14, wherein the plurality of contracted medical facilities comprise facilities in which a quantity determined by a percentage of revenue associated with the group of insured patients exceeds a cost associated with waiving said at least a portion of the deductible.

18. The system of claim 17, wherein at least one of the plurality of contracted medical facilities is identified by:
identifying a number of reported admissions in an area;
extrapolating a number of insured patients using the number of reported admissions;
evaluating demographic data to determine at least one location associated with the number of reported admissions;
evaluating financial data of said at least one of the plurality of contracted medical facilities within said at least one location to determine a percentage of revenue associated with the group of insured patients;
performing an analysis using a processor in communication with computer instructions for instructing the processor to analyze the percentage of revenue, the number of insured patients, the demographic data, the financial data, the number of reported admissions, or combinations thereof, to determine a prospective result; and
contracting said at least one of the plurality of contracted medical facilities if the prospective result indicates that increased revenue will exceed the cost associated with waiving said at least a portion of the deductible.

19. The system of claim 14, wherein the plurality of contracted medical facilities comprise facilities in which costs associated with the group of insured patients are determined to be a loss leader.

20. The system of claim 19, wherein at least one of the plurality of contracted medical facilities is identified by:
using census data to identify a market area;
identifying at least one medical facility within the market area;
determining a percentage of revenue of said at least one medical facility associated with the group of insured patients;
determining an admission count, an average length of stay, or combinations thereof, associated with the group of insured patients;
performing an analysis using a processor in communication with computer instructions for instructing the processor to the percentage of revenue, the admission count, the average length of stay, or combinations thereof, to determine whether the group of insured patients constitutes a loss leader; and
contracting said at least one medical facility if the percentage of revenue, the admission count, the average length of stay, or combinations thereof, indicate that the group of insured patients constitutes a loss leader.

21. The system of claim 14, wherein at least one of the plurality of contracted medical facilities is identified by analyzing services offered, outcomes reporting, re-admission rates, admitting privileges from specialty physicians, or combinations thereof.

22. A computer implemented system for reducing costs of a healthcare transaction, the computer-implemented system comprising:
a processor in communication with a data storage medium having a list of contracted medical facilities and contracted insurance providers stored thereon;
computer instructions in communication with the processor for instructing the processor to perform an analysis to identify at least one medical facility for which contracting is predicted to increase revenue;
wherein the plurality of contracted medical facilities contract to waive at least a portion of a deductible for a group of insured patients, wherein the plurality of contracted insurance providers contract to provide a premium credit to each insured patient that conducts a healthcare transaction with at least one of the medical facilities, wherein an insured patient conducts an inpatient healthcare transaction with at least one of the contracted medical facilities, wherein said at least one of the contracted medical facilities waives said at least a portion of the deductible for the insured patient, and wherein at least one of the contracted insurance providers associated with the insured patient provides the premium credit to the insured patient, thereby incentivizing insured patients to conduct healthcare transactions with the plurality of contracted medical facilities and increasing revenue of the plurality of contracted medical facilities, and thereby reducing costs of healthcare transactions for insured patients and the plurality of contracted insurance providers.

23. The system of claim 22, wherein the computer instructions for instructing the processor to perform the analysis instruct the processor to:
identify a number of reported admissions in an area;
extrapolate a number of insured patients using the number of reported admissions;
evaluate demographic data to determine at least one location associated with the number of reported admissions;
evaluate financial data of at least one medical facility within said at least one location to determine a percentage of revenue associated with the group of insured patients; and
analyze the percentage of revenue, the number of insured patients, the demographic data, the financial data, the number of reported admissions, or combinations thereof, to determine a prospective result, wherein prospective result includes an indication whether increased revenue will exceed the cost associated with waiving said at least a portion of the deductible.

24. The system of claim 22, wherein the computer instructions for instructing the processor to perform the analysis instruct the processor to:
use census data to identify a market area;
identify at least one medical facility within the market area;
determine a percentage of revenue of said at least one medical facility associated with the group of insured patients;
determine an admission count, an average length of stay, or combinations thereof, associated with the group of insured patients; and
analyze the percentage of revenue, the admission count, the average length of stay, or combinations thereof, to determine a prospective result, wherein the prospective result includes an indication whether the group of insured patients constitutes a loss leader.
